(19) United States
(12) Patent Application Publication
(10) Pub. No.: US 2012/0253575 A1
(43) Pub. Date: Oct. 4, 2012

(54) METHOD FOR CONTROLLING OPERATION OF A HYBRID AUTOMOTIVE VEHICLE AND VEHICLE ADAPTED TO SUCH A METHOD

(75) Inventors: Philippe Le Brusq, Lyon (FR); Guy Mouden, Saint Priest (FR)

(73) Assignee: RENAULT TRUCKS, Saint Priest (FR)

(21) Appl. No.: 13/513,789

(22) PCT Filed: Dec. 8, 2009
(86) PCT No.: PCT/IB2009/007970

§ 371 Date: Jun. 4, 2012

(51) Int. Cl. B60W 20/00

(52) U.S. Cl. 701/22; 180/65.28; 180/65.29; 903/903

(57) ABSTRACT

A method is provided for controlling operation of a hybrid automotive vehicle, equipped with an internal combustion engine, at least one electric machine connected to a traction battery set and at least one logical control unit. Each of the internal combustion engine and the electric machine is adapted to deliver torque to a driveline of the vehicle and the method includes a) watch of an activity area of the vehicle and/or watch of an electrical/electronic network of the vehicle in order to detect a user in the activity area and/or the use of an auxiliary equipment of the vehicle; b) determination of whether or not the watch of step a) has detected, during a given period of time, a user in the activity area and/or the use of an auxiliary equipment of the vehicle; c) if the result of the determination of step b) is negative, initiate a shutdown procedure of at least the traction battery set.

### TECHNICAL FIELD OF THE INVENTION

This invention concerns a method for controlling the operation of a hybrid automotive vehicle equipped with an internal combustion engine, an electric machine, automatic restart means for the internal combustion engine and a logical control unit, each of the internal combustion engine and the electric machine being adapted to deliver torque to a driveline of the vehicle. The invention also concerns a hybrid automotive vehicle adapted to perform such a method.

### BACKGROUND OF THE INVENTION

Parallel hybrid vehicles may be operated either by their combustion engine and/or by their electric machine. The vehicle electronics manage which of the two are active, depending on the vehicle's operating parameters. When the hybrid vehicle is stopped, it can therefore very quickly and automatically shut down its combustion engine, with the electrical machine being ready to deliver power to the driven wheels as soon as the driver requests, for example by depressing an accelerator pedal. The driveline can be said to remain active. In a conventional vehicle, in the same situation, the combustion engine is left idling but is not stopped, so that the driver is aware that the driveline of the vehicle is still active. To the contrary, in a hybrid vehicle, the driveline is still operational, but the driver is not alerted by any noise. When the vehicle is to be parked for a long period of time, the driver should shut down the vehicle's battery, meaning not only shutting down the combustion engine, but also shutting down the electric propulsion network to avoid any unnecessary depletion of the battery. But, since in a hybrid vehicle the driveline may remain active without making any significant noise, there is a risk that a hybrid vehicle may be parked without its driveline being shut down. In such a case, it may happen that, after a certain period of time, the mere consumption of electric current necessary to keep the vehicle in a ready state causes a depletion of the battery to such a point that the combustion engine may be restarted in order to charge the battery. Indeed, hybrid vehicles are equipped with automatic restart means for the internal combustion engine, so that the engine is restarted automatically when the state of charge of the battery set reaches a low level, in order to avoid damages on the batteries. If this occurs when the hybrid vehicle is forgotten in a close place, such as a garage, this leads to unexpected gas exhaust and fuel over-consumption. Gas exhaust in a close space provokes pollution and induces safety issues.

A technique used so far for hybrid vehicles is to disable the automatic restart means when the driver door is open. Another technique used for conventional vehicles parked with the combustion engine still running is to shutdown the engine after a certain amount of time has elapsed.

These techniques have major drawbacks, because they do not leave any options for the user.

### SUMMARY OF THE INVENTION

This invention aims at proposing a new method for controlling operation for a hybrid automotive vehicle which watches the presence or the activity of a user in or outside the vehicle and determines, on this basis, whether or not the entire driveline and the electrical auxiliary equipment should be shutdown.

To this end, the invention concerns a method for controlling operation of a hybrid automotive vehicle, equipped with an internal combustion engine, at least one electric machine connected to a traction battery set and at least one logical control unit. This method is characterized in that each of the internal combustion engine and the electric machine is adapted to deliver torque to a driveline of the vehicle, and in that it comprises at least the following steps:

a) watch of an activity area of the vehicle and/or watch of an electrical/electronic network of the vehicle in order to detect a user in the activity area and/or the use of an auxiliary equipment of the vehicle;

b) determination of whether or not the watch of step a) has detected, during a given period of time, a user in the activity area and/or the use of an auxiliary equipment of the vehicle;

c) if the result of the determination of step b) is negative, initiate a shutdown procedure of at least the traction battery set.

Thanks to the invention, the driver can use cabin electrical equipments and auxiliary equipments outside of the vehicle, even if the internal combustion engine has been shutdown. Moreover, it prevents unexpected internal combustion engine restarts and safety issues, if no activity has been detected in or around the vehicle for a given period of time.

According to further aspects of the invention which are advantageous but not compulsory, such a method might incorporate one or several of the following features:
The shutdown procedure of step c) includes inhibiting automatic restart means of the internal combustion engine.
The shutdown procedure includes the monitoring of a load level of the traction battery set, and the effective shutdown of the traction battery set is performed when said load level reaches a low threshold value.
The effective shutdown of the traction battery set includes isolating said battery set from an electric traction power network.
The shutdown procedure includes shutting down of auxiliary equipments of said vehicle.
The activity area watched at step a) is a cabin of the vehicle.
The activity area watched at step a) is in the vicinity of the vehicle, outside of the vehicle.
The electric/electronic network is watched at step a) by monitoring an electrical signal in said network.
The electrical signal corresponds to the actuation by the user of an input device.
The electric/electronic network is watched at step a) by monitoring the power consumption of an auxiliary equipment connected to the network.
The method is inhibited when said vehicle is in an initialization stage and/or when the load and/or the temperature of the traction battery set feeding said electric machine is below a threshold load value.

The threshold load value is preferably set to permit, after the given period of time, to start the internal combustion engine or to move the vehicle by means of the electric machine, without further loading of the traction battery set.

The invention also concerns a hybrid automotive vehicle with which the above-mentioned method can be implemented. More precisely, the invention concerns a hybrid automotive vehicle equipped with an internal combustion engine, at least one electric machine connected to a traction battery set, and at least one logical control unit, each of the internal combustion engine and the electric machine being adapted to deliver torque to a driveline of the vehicle. This vehicle is characterized in that it comprises means to detect a user in an activity area of the vehicle or the use of an auxiliary equipment of the vehicle, and in that the logical control unit is adapted to initiate a shutdown procedure of at least the traction battery set, on the basis of a signal emitted by the detection means during a given period of time.

According to an advantageous aspect of the invention, the above-mentioned logical control unit is adapted to inhibit automatic restart means of the internal combustion engine.

### BRIEF DESCRIPTION OF THE DRAWINGS

The invention will now be explained in correspondence with the annexed figures and as an illustrative example, without restricting the object of the invention. In the annexed figures:

FIG. 1 is a schematic representation of a truck embodying the invention;

FIG. 2 is a block diagram representing a method according to the invention.

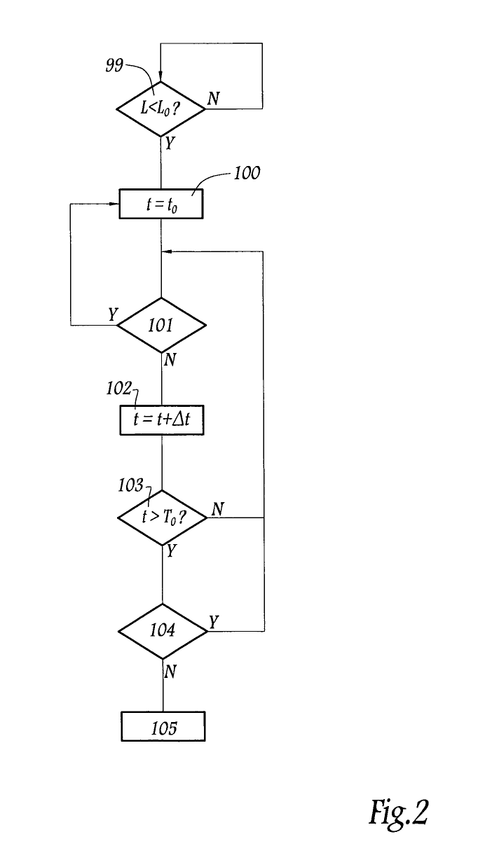

### DETAILED DESCRIPTION OF SOME EMBODIMENTS

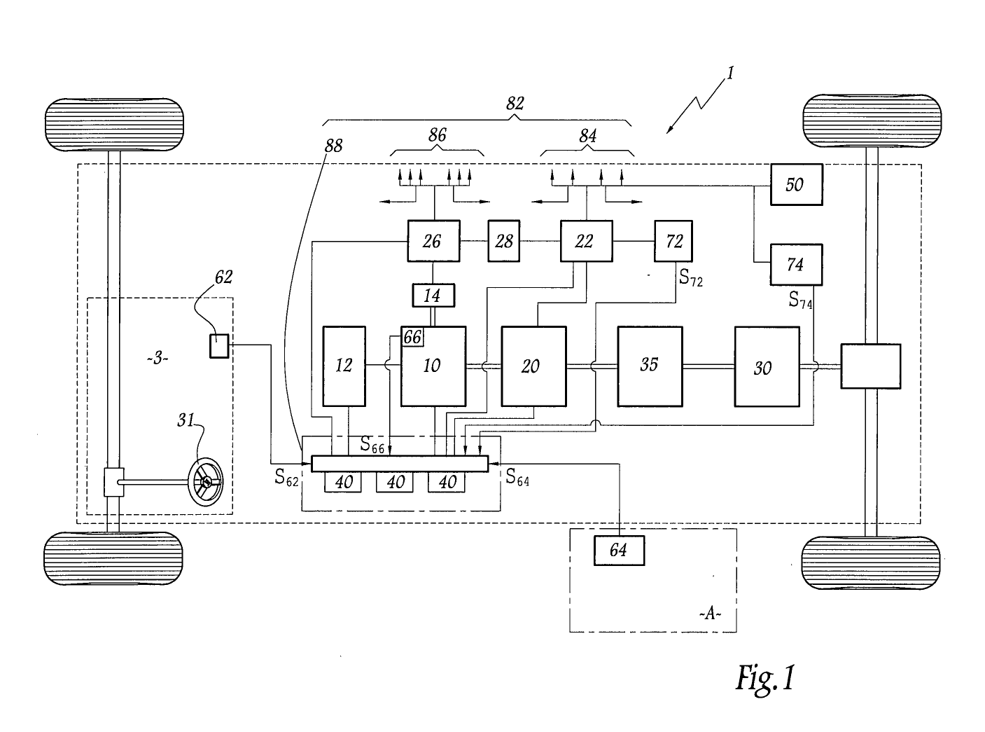

As illustrated on FIG. 1, a hybrid vehicle 1 comprises an internal combustion engine 10, a traction electric machine 20 fed by a traction battery set 22, each of the internal combustion engine and traction electric machine being adapted to deliver torque to a driveline 30 of the vehicle through a gearbox 35. The traction battery set 22 and the traction electric machine 20 are part of a vehicle electric/electronic network 82. Said vehicle network comprises for example a high voltage electric traction power network 84, to which the traction battery set 22 and the traction electric machine 20 are connected. The vehicle network 82 may further comprise a low voltage electrical service power network 86, and an electronic control network 88, each of which can be considered as a sub-network of the vehicle electric/electronic network 82.

The internal combustion engine 10 is also adapted to deliver torque to the traction electric machine 20 in order for it to generate electric power. The internal combustion engine 10 may be associated with automatic restart means 12. The latter may comprise a stand-alone starter motor, or the traction electric machine 20 may be used for starting the engine 10, in which case the automatic restart means 12 comprise said traction electric machine 20. Said automatic restart means 12 are controlled by the electronic control network 88 of the vehicle. The power networks may be connected one to the other, for example through a suitable converter, to exchange electric energy. The low voltage power network 86 may derive electricity from an alternator 14 driven by internal combustion engine 10, from a low voltage battery set 26, and/or from the high voltage network 84 through a suitable converter 28.

The hybrid vehicle 1 includes a cabin 3 comprising a steering wheel 31 and other equipments which are not represented on FIG. 1.

The hybrid vehicle 1 may be provided with an auxiliary equipment 50, such as an electric tailgate, an electrically driven hydraulic pump, or simply an electric motor as a source of mechanical power for an auxiliary system. The auxiliary equipment is connected to the vehicle electric/electronic network 82. Depending inter alia on its power consumption, it can be connected to the high or low voltage power networks or to a bodybuilder electric power network, not represented, operating at an intermediate voltage, and it is also preferably connected to the electronic control network 88. The auxiliary equipment 50 is represented here as connected to the traction power network 84.

The electronic control network 88 monitors and controls the operation of the various vehicle components, including the internal combustion engine 10, the traction electric machine 20 and the electric power networks. The electronic control network may comprise components such as electronic control units 40, one or several databuses, relays, sensors and input devices through which a user of the vehicle may interact with the electronic control network 88 to control one or several of the vehicle components.

The hybrid vehicle 1 also comprises detection means for detecting that the user is in the vehicle or in its vicinity. These detections means are preferably connected to the electronic control network 88, and are therefore part of it.

The detection means may include detection means 62 which are adapted to detect the presence of a user in the cabin 3 and to deliver an electric signal S₆₂ which can be used by the electronic control network 88. These detection means 62 may include, for instance, a sensor in the driver's seat, some switches in the pedals or a volumetric sensor monitoring the internal volume of the cabin 3.

The detection means may include detection means 64 which are adapted to detect the presence of a user in the vicinity of the vehicle. Detection means 64 may include a volumetric sensor or any equivalent means. Detection means 64 cover an area A next to vehicle 1 where the driver usually stands during loading/unloading operations. This area A is represented on the left side of the vehicle 1 on FIG. 1. It can also be located on the right side and/or on the back side of vehicle 1. In such a case, detection means 64 can include several sensors. Detection means 64 can also include a mean to measure the distance between the vehicle and a transponder located in a remote keyless system card, born by the driver. These detection means 64 are adapted to generate an electric signal S₆₄, which can be used by the electronic control network 88.

The detection means may include a monitoring unit 74 adapted to measure the power consumption of the auxiliary equipment 50. As shown, this monitoring unit 74 is also adapted to transmit, in the form of an electric signal S₇₄, a value corresponding to the power consumption of the auxiliary equipment 50 which can be used by the electronic control network 88 to determine whether the equipment is in use.

Alternatively or in combination, the detection means may comprise means for detecting that an electrical device of the vehicle is used by the user. For example, such detection means could comprise monitoring that an input device of the electronic control network 88 is actuated by the user or that an on-board electric appliance is used by the user. For example, if the user touches the sound volume button of a radio device connected to the electronic control network 88, the latter can determine that the user is on-board the vehicle.

According to a further enhanced embodiment of the invention, the internal combustion engine 10 may be provided with monitoring means 66 for determining whether or not the internal combustion engine 10 is in an initialization stage. For instance, such monitoring means 66 may include sensors measuring the temperature of the oil or of the cooling water of the internal combustion engine 10. Such means 66 are adapted to generate an electric signal S₆₆ which can be used by the electronic control network 88.

Alternatively or in combination, the hybrid vehicle 1 may comprise a monitoring unit 72, connected to battery set 22, adapted to measure the state of charge of the battery set. This monitoring unit 72 may also be adapted to transmit, in the form of an electric signal S₇₂, the load value corresponding to the state of charge of the traction battery set 22.

At an initialization step 100 of the method of the invention, a timer value t is set to an initial value t₀.

A first step 101 of the method of the invention can be implemented with detection means 62 and/or 64. In this step, one determines if a user is in an activity area of the vehicle 1. An activity area of vehicle 1 is an area where a user can be for a given activity, for instance cabin 3 and/or loading/unloading area A. The presence of a user in such an activity area is detected by detection means 62 or 64.

If a user is detected in an activity area, the method returns to step 100. If no presence is detected in an activity area the time value t of the timer is increased at a second step 102 by adding an incremental time value Δt to it. The incremental time value Δt can be for example in the range of 10 milliseconds to several tens of seconds.

At a third step 103, the timer value t is compared to a threshold time value T₀. If the timer value t is below this threshold time value T₀, step 101 is repeated. Steps 102 and 103 are also repeated as long as the result of the watch at step 101 is negative. Therefore, timer value t increases step by step by the value At as long as no presence is detected in the activity areas 3 and A.

The fact that the timer value t reaches the threshold value T₀ corresponds to an absence and/or inactivity period of the truck, for a duration of at least T₀. Then, a shutdown of the vehicle can be implemented. In fact, by determining at step 103 whether or not time value t reaches the threshold value T₀, one determines whether or not a user has been detected in activity areas 3 and A during a period of time between t₀ and T₀.

For instance, T₀ can be set to 15 minutes. This threshold value can be adjustable.

In case t becomes larger than T₀ without detection of a user in an activity area, another step 104 of the method can be implemented with monitoring means 66. In this step 104, one determines whether the hybrid vehicle 1 is in an initialization state, for instance by measuring temperature in the internal combustion engine 10. If the hybrid vehicle 1 is at the beginning of a warm up, a low temperature may be measured by monitoring means 66 and, as a consequence, the result of the determination made at step 104 will be positive. In that case, the method goes back to step 101. This step 104 is useful in cold seasons or cold countries, when vehicles need to warm up a while before the user drives.

It should be noted that step 104 is not compulsory, in particular in countries where engine warm-up is not necessary.

If it appears that the vehicle 1 is not in an initialization stage, a further step 105 is executed. In this step, at least the power supplies of the electric machine 20 are shut down.

Preferably, at this time, a complete shutdown of the vehicle driveline is performed. For example, such a shutdown will be driven by electronic control network 88 which will therefore initiate a shutdown sequence for the equipments fed by the high voltage traction network 84. This would for example involve stopping any converters and electric motors, if they are not already stopped. Then, the electrical sources of the high voltage traction network 84 such as the traction battery 22 are disconnected and isolated for the rest of the network. Also, the service network alternator 14 is stopped or its excitation is shutdown. In the mean time, the internal combustion engine 10 may also be stopped if not already stopped. At this stage, electricity may still be available on the low voltage network 86, from the low voltage battery set 26. Therefore, it can be provided that a number of electrical consumers supplied by said low voltage network 86 are isolated from the battery set 26. This can be achieved by the opening of an electric controlled main switch or by the opening of a series of electronically controlled relays on the supply lines of said components.

According to an optional aspect of the invention, the method of the invention can comprise, prior to step 100, another step 99 where monitoring unit 72 measures the load L of the traction battery set 22 feeding the traction electric machine 20. If the vehicle 1 is left idle with the traction battery set 22 still delivering current to some auxiliary equipments, the load of the battery set 22 decreases. If the load L of traction battery set 22 is below a threshold load value L₀, steps 100 to 105 are automatically initiated. This aspect permits to avoid damages to the traction battery set 22 and unexpected restart of the internal combustion engine 10 when the battery set load L is low.

Moreover, the threshold load value L₀ is set to permit, after a period of time of a duration equal to T₀ has expired, to start the internal combustion engine 10 or to move the vehicle 1 by means of traction electric machine 20, without further loading of the traction battery set 22. This aspect allows a user to move the vehicle 1 without having to restart the internal combustion engine 10 in a close space and, as a consequence, to avoid fuel overconsumption and pollution or safety issues.

According to a second approach, during first step 101, instead of detecting the presence of a user in activity areas 3 and A, one may determine if auxiliary equipment 50 is used. This can be done by measuring the power consumption in the electric power network to which equipment 50 is connected. If auxiliary equipment 50 is used, power will be absorbed from the electrical power network. This power consumption will be detected by a surge of electric power or intensity measured by monitoring unit 74. If no use of the auxiliary equipment 50 is detected, steps 102 to 105 are executed in the same manner as in the first approach.

According to a third approach, step 101 can be executed to detect both the presence of a user in an activity area and the use of an auxiliary equipment. In this case, step 102 is initiated if neither presence in an activity area nor use of auxiliary equipment 50 have been detected. Steps 103 to 105 are then executed in the same manner as in the first approach.

The invention is applicable with trucks, buses, cars and any other automotive hybrid vehicle.

1. Method for controlling operation of a hybrid automotive vehicle, equipped with:
an internal combustion engine,
at least one electric machine connected to a traction battery set,
an electrical/electronic network comprising an electric power network to which the traction battery set and electric machine are connected,
at least one logical control unit,
wherein each of the internal combustion engine and the electric machine is adapted to deliver torque to a driveline of the vehicle, and wherein the method comprises at least the following steps:
a) watch of an activity area of the vehicle and/or watch of an electrical/electronic network of the vehicle in order to detect a user in the activity area and/or the use of an auxiliary equipment of the vehicle;
b) determination of whether or not the watch of step a) has detected, during a given period of time, a user in the activity area and/or the use of an auxiliary equipment of the vehicle;
c) if the result of the determination of step b) is negative, initiate a shutdown procedure of at least the traction battery set, wherein the effective shutdown of the traction battery set includes isolating the traction battery set from the electric traction power network.

2. Method according to claim 1, wherein the shutdown procedure of step c) includes inhibiting automatic restart means of the internal combustion engine.

3. Method according to claim 1, wherein the shutdown procedure includes the monitoring of a load level of the traction battery set, and wherein the effective shutdown of the traction battery set is performed when the load level reaches a low threshold value.

4. (canceled)

5. Method according to claim 1, wherein the shutdown procedure includes shutting down of auxiliary equipments of the vehicle.

6. Method according to claim 1, wherein the activity area watched at step a) is a cabin of the vehicle.

7. Method according to claim 1, wherein the activity area watched at step a) is in the vicinity of the vehicle, outside of the vehicle.

8. Method according to claim 1, wherein the electric/electronic network is watched at step a) by monitoring an electrical signal in the network.

9. Method according to claim 8, wherein the electrical signal corresponds to the actuation by the user of an input device.

10. Method according to claim 1, wherein the electrical/electronic network is watched at step a) by monitoring the power consumption of an auxiliary equipment connected to the network.

11. Method according to claim 1, wherein the method is inhibited when the vehicle is in an initialization stage.

12. Method according to claim 3, wherein the threshold load value is set to permit, after the given period of time, to start the internal combustion engine or to move the vehicle by means of the electric machine, without further loading of the traction battery set.

13. Hybrid automotive vehicle equipped with:
an internal combustion engine,
at least one electric machine connected to a traction battery set,
an electrical/electronic network comprising an electric power network to which the traction battery set and electric machine are connected,
at least one logical control unit,
each of the internal combustion engine and the electric machine being adapted to deliver torque to a driveline of the vehicle, wherein the vehicle comprises means to detect a user in an activity area of the vehicle or the use of an auxiliary equipment of the vehicle and wherein the logical control unit is adapted to initiate a shutdown procedure of at least the traction battery set, on the basis of a signal emitted by the detection means during a given period of time and in order to isolate the traction battery set from the electric traction power network.

14. Vehicle according to claim 13, wherein the logical control unit is adapted to inhibit automatic restart means of the internal combustion engine.
